(19) United States
(12) Patent Application Publication
(10) Pub. No.: US 2010/0172544 A1
(43) Pub. Date: Jul. 8, 2010

(54) METHOD OF MEASURING, ON THE FLY, THE HEIGHT OF AN ELECTROLYSIS ANODE

(75) Inventors: Alain Van Acker, Orchies (FR); Alain Rose, Beaucamps-Ligny (FR); Patrick Marchand, Lesquin (FR)

Correspondence Address: DENNISON, SCHULTZ & MACDONALD, 1727 KING STREET, SUITE 105, ALEXANDRIA, VA, 22314, US

(73) Assignee: E.C.L., Ronchin (FR)

(21) Appl. No.: 12/303,575

(22) PCT Filed: Jun. 1, 2007
(86) PCT No.: PCT/FR07/00911

§ 371 Date: Jan. 29, 2009

(30) Foreign Application Priority Data
Jun. 9, 2006 (FR) 0605125

(51) Int. Cl. G06K 9/00; G01B 17/00; G01C 5/00; G01B 11/02; G01S 3/80

(52) U.S. Cl. 382/106; 73/596; 356/3; 356/634; 367/118

(57) ABSTRACT

An on-the-fly method for measuring the length, along an axis (z′z) of an anode (20) used in the production of aluminium by molten salt electrolysis in which:
i) said anode is suspended from a gripping member (13a) which is fitted with a displacement sensor measuring the vertical position of the point of attachment (O);
ii) said gripping member is moved vertically so that the lower surface (21a) of the anode passes through a plane (P) formed by n beams (f₁, . . . , fᵢ, . . . , fₙ) and, each time one of said beams i (i=1 to n) is disturbed by the lower surface of the anode passing through it, the vertical position hᵢ of said point of attachment (O) is measured;
iii) the angle of inclination zz′ of the anode stem is measured and the distance between the point of attachment and the lower surface (21a) of the anode block (21) is deduced based on values measured hᵢ (i=1 to n), and the inclination value of the anode stem.

### TECHNICAL FIELD

The invention concerns the measurement of the height of electrolysis anodes, particularly those used in plants producing aluminium by molten salt electrolysis. Precise knowledge of the height of said new or worn anodes is essential, and especially their “functional” height, i.e. the distance between the point of attachment of the anode and the lower surface of the anode block, in order to limit disturbances during operation of the electrolysis cell which result from various handling operations related to the replacement of said anodes.

### BACKGROUND OF RELATED ART

Aluminium is produced industrially by molten salt electrolysis in electrolysis cells according to the well-known Hall-Héroult process. The French patent application FR 2 806 742 (corresponding to American U.S. Pat. No. 6,409,894) describes installations of an electrolysis plant intended to produce aluminium.

According to the most widespread technology, the electrolytic cells consist of a plurality of “prebaked” anodes made of carbonaceous materials that are consumed during electrolytic reduction reactions of the aluminium. The progressive consumption of the anodes requires servicing work on the electrolysis cells and particularly the replacement of worn anodes by new anodes.

In order to carry out the replacement of the worn anodes by new anodes, a service unit is generally used, called a “Pot Tending Assembly” (PTA) or “Pot Tending Machine” (PTM). This service unit comprises a mobile gantry which can be translated above the electrolysis cells, and along series of cells, and at least one service machine that can be moved on the gantry, including a carriage and a service module provided with, among other elements, anode handling devices. International patent application WO2005/095676 of the applicant describes a compact service module.

In order to limit disturbance to the operation of an electrolysis cell while an anode is being replaced, it is preferable to place the new anode so that its lower surface is at the same level as that of the other anodes of the cell. To ensure correct levelling of the new anodes, the following conventional method is still used:
prior to its removal, the stem of the worn anode is marked with a chalk in a location corresponding to a mark determined on the anode frame;
the worn anode is extracted from the cell and placed on a reference surface, typically a metal platform;
the level of the chalk mark on the stem is recorded, the worn anode is is removed and a new anode is placed on said reference surface;
a chalk mark is made on the stem of the new anode at the level recorded;
the new anode is placed on the anode frame so that the chalk mark is at the level of the mark determined on the anode frame.

These essentially manual operations require an operator to intervene in the zone of action of the anode handling tools, thus exposing him to the hazards inherent to these operations, such as hazards associated with load unhooking and the projection of molten metal.

In a preferred embodiment of the French application by the applicant, for which the filing number is 04 09508, it is proposed to replace the worn anodes using a new process that requires less manual intervention:

a) an anode handling tool is used comprising a positioning device, a gripping member and a vertical position sensor used to measure the vertical distance between a specific point of the gripping member in relation to a given reference level N, and
b) a sound or electromagnetic wave beam is placed in a plane parallel to the reference level N;
c) this beam is placed in the trajectory of the worn anode and in that of the replacement anode such that, when the anodes pass into the beam, dimensional readings are taken on-the-fly by means of a displacement sensor and are then used to correctly place the replacement anode.

The dimensional readings are taken in the following manner:
a gripping member is placed in position to grasp the metal stem of the worn anode and the vertical distance between the reference level N and a particular point of the gripping member is measured by a displacement sensor when the gripping member has grasped said metal rod;
the worn anode is removed from the electrolysis cell, the anode block of this anode is passed through said beam in a vertical movement and a displacement sensor is used to measure the vertical distance between the reference level N and the particular point of the gripping member at the moment when the particular surface of the gripped anode passes through said beam;
the metal stem of a replacement anode is gripped by a gripping member, preferably the same in order to use the same reference point and to thus avoid additional positioning corrections;
the anode block of this anode is passed through said beam in a vertical movement and a displacement sensor is used to measure the vertical distance between the reference level N and the particular point of the gripping member at the moment when the particular surface of the anode passes through said beam;
the vertical position of the replacement anode in the cell is determined from the values measures previously, and by considering various other corrections, particularly those due to weight and temperature differences between the worn anode at the time it is grasped and the replacement anode the moment it is put into place;
finally, the replacement anode is put into the position determined during the previous step, in the space initially occupied by the worn anode.

### THE PROBLEM

This process offers a great advantage in relation to the traditional method described above as it allows the number of handling operations to be reduced during replacement of an anode. It has, however, the drawback of being highly dependent on the particular surface of the anode which has been selected to carry out these measurements. In practice, the most suitable surface for this type of measurement is the lower surface of the anode block. But a worn anode no longer has a perfectly parallelepipedic geometry with sharp edges. In addition, if, for any reason, the anode is unbalanced when it crosses the beam, the plane of the lower surface of the carbon block is no is longer parallel to the beam, such that the beam is not disturbed from the start by the lower surface of the block but by an eroded edge, or even a point on this edge. With the common geometries considered and a typical angular shift of 3°, this may lead to a shift in the estimation of the levelling in the order of 40 mm for an anode whose block measures 1,550 mm in length. Such an error is not compatible with the operation of the tanks.

The applicant has thus sought a procedure and means that allow these drawbacks to be avoided and particularly to make use of the process described in French application 04 09508 in an industrially and economically satisfactory manner.

### PURPOSE OF THE INVENTION

A first subject of the invention is a method of measuring, on the fly, the length of a production anode along direction (z′z), typically an anode for the production of aluminium by molten salt electrolysis, said anode comprising a stem which extends substantially along an axis, in direction (z′z), and whose orthogonal cross section is a rectangle whose sides follow directions (x′x) and (y′y), as well as a carbon block—also referred to as the anode block—of right-angled parallelepipedic overall shape, the height of which extends along direction (z′z) and the orthogonal section of which has sides substantially parallel to (xx′) and (yy′). It is a method in which:
i) said anode is suspended from a gripping member which grasps, at the level of the point of attachment, the anode stem so that it cannot turn about its axis. The movement of said gripping member is guided such that it moves along the vertical axis Z′Z and such that, when it grasps a new anode, directions (x′x) and (y′y) remain essentially parallel to two given horizontal directions (X′X) and (Y′Y), orthogonal between each other. These directions typically, although not necessarily, correspond to the small and large side of the electrolysis cell, respectively. Said gripping member is fitted with a displacement sensor enabling the vertical position of the point of attachment to be measured, i.e. the vertical distance between a horizontal reference level (N) and said point of attachment;
ii) said gripping member is moved vertically such that the lower surface of the anode block passes through at least a plane formed by a plurality of n sound or electromagnetic wave beams, and a displacement sensor is used to record the vertical position hᵢ (i=1 to n) of said point of attachment each time one of said beams is disturbed by the lower surface of the anode passing through it;
   Said method is characterized in that:
iii) the angle of inclination of the axis (z′z) of the anode stem is also measured in relation to the vertical (Z′Z) in order to describe this angle of inclination and the values measured hᵢ (i=1 to n), the distance between the point of attachment and the lower surface of the anode block.

The characteristic steps ii) and iii) of the method as described above do not necessarily take place in chronological order. As such, according to possible variants of the invention, the angle of inclination of the axis (z′z) of the stem may be measured when the anode is stopped, before its vertical movement, or, on the contrary, on-the-fly during its vertical movement and, in the latter case, it can be performed before or after the first of n beams are disturbed.

The method according to the invention is an on-the-fly measurement method, i.e. not requiring the immobilisation and placement of the anode in a storage location, on a pallet or vehicle. The measurement is taken when the anode is suspended, the contact between the anode and the gripping member taking place in a zone, the barycentre of which is referred to as the “point of attachment”, that can be considered as belonging to both the gripping member and the anode stem. This measurement method is intended to determine the height of the anode, or more precisely, a “functional” height corresponding to the distance along (z′z) between said point of attachment and the lower surface of the anode block. In order for this measurement to be is valid regardless of the condition of the anode, the change in the orientation of the anode must be taken into account when it is suspended, which can result from the imbalance caused by wear, or even deterioration, of the anode block.

The new anode is perfectly balanced such that the directions (x′x), (y′y), and (z′z) correspond to those of its axes of symmetry. The gripping member is arranged such that, when the new anode is suspended, the directions (x′x) and (y′y) remain parallel to two given horizontal directions (X′X) and (Y′Y). These directions can be parallel to the small and large side of the electrolysis cell, respectfully, particularly if the measurement is taken near the electrolysis cell. Indeed, when the new anode moves near the electrolysis cell during anode replacement operations, it is displaced such that its axis (z′z) is vertical and that the directions (x′x) and (y′y) are parallel to the small and large side of said electrolysis cell, the direction of the large side of the cell corresponding to the direction of the anode frame on which the anode is connected.

However, when suspended, the worn anode no longer demonstrates its initial equilibrium such that its axes (x′x), (y′y), and (z′z) are no longer parallel to axes (X′X), (Y′Y) and (Z′Z). This imbalance, which translates by a horizontality defect of the lower surface of the anode block, may be due to a distribution defect of the anode covering (the mixture of crushed melt and alumina which is poured into the electrolysis bath and on the upper surface of the anode blocks) and/or to local deterioration of the anode block (local absence of carbonaceous matter). This defect nevertheless corresponds to a slight inclination, at most a few degrees in relation to the horizontal plane, and the consequences of this angular difference must be evaluated when estimating the true height of the anode.

The gripping member, considered in the scope of the invention, moves vertically and grasps the anode such that the stem cannot turn about its axis z′z. This gripping member can belong to a handling tool that is habitually used during anode replacement operations, such as that described in international application WO2004/079046. Generally speaking, such a handling tool comprises a gripping member mounted on a positioning device which is itself attached to the carriage of a service machine which moves on a mobile gantry ready to be translated above and along the series of electrolysis cells. Said positioning device is typically a telescopic arm arranged vertically, comprised of at least two masts sliding one inside the other, one mast being moved by an actuator and being guided by the other mast attached to said service machine. The gripping member, fixed at the end of the mast moved by an actuator, moves vertically, without being subject to rotation about axis z′z or significant transverse movement.

The gripping system of the gripping member prevents any rotation about the axis (z′z) of the stem. It may, for example, be a grip whose articulated branches swivel about a horizontal axis which remains parallel to a given direction, typically coinciding with the axis (X′X) or (Y′Y). In this method of the invention, each articulated branch of the grip includes for example at least one projection, also called a “pawl”, which fits, with some play, inside a bore of the anode stem. Said bore, which may or may not fully penetrate, extends along the direction perpendicular to that of the pivot axis of the branches of the grip, i.e. perpendicular to the small side or the large side of the stem section. These means of fixing of complementary shapes may obviously have a different geometrical configuration: for example, a bore worked into the branch of the grip and the portions of shaft projecting from the small faces or the large faces of the stem or any other combination of geometrical shapes which make it possible to lock and to raise the anode. In this method of the invention also, blanks which frame the other faces of the stem can advantageously be arranged perpendicular to said means of fixing, i.e. parallel to the pivot axis of the articulated branches, so that, when the grip is closed, the end of the stem cannot undergo any substantial transverse movement in relation to the positioning device.

Said gripping member is provided with a displacement sensor which makes it possible to measure the vertical position of a particular point of the gripping member in relation to a horizontal reference level (N). The position sensor may, for example, be an encoder with cable or a laser rangefinder. Typically, it is fixed rigidly to the part of the positioning device that is attached to the service machine, and is used to measure the relative distance between its position and that of a particular point of the gripping member which corresponds, in then case of an encoder with a cable, to the fixing point of the mobile end of the cable or, if it is a laser rangefinder, to the point of the gripping member aimed at by the laser beam. The vertical distance between this particular point and the point of attachment can be easily worked out, so that the displacement sensor constantly gives the vertical position of the point of attachment, i.e. the distance between the reference level (N) and the point of attachment.

For example, if the gripping member is a grip, the distance between the particular point and the pivot axis of the articulated branches is known, the distance existing between the pivot axis and the axes of the pawls is known and the play between said pawls and bores of the rod is minimum, so that it is possible to determine the vertical position of the point of attachment with a high degree of accuracy. To make sure that the vertical distance between the particular point and the point of attachment remains constant throughout the measurements, it is advantageous to provide the positioning device with a means of measurement of the tension in the tool, such as an axial dynamometer, which is used to determine the moment when the kinematic chain of the tool is undergoing traction and the moment when the mechanical play is completely taken up.

The anode is suspended from the gripping member, for example via said bore and from said projections, in a fixing zone located on the stem, at a known position on said stem. Because of the imbalance caused by wear, its axes (x′x), (y′y) and (z′z) no longer necessarily coincide with the initial axes (X′X), (Y′Y) and (Z′Z). Although the anode is prevented from rotating about its axis (z′z) by the end of its rod, it is nevertheless likely to behave like a pendulum that may oscillate around the point of attachment. In order for these oscillations to not disturb the measurements too greatly, the actuators which make the gripping member move in the vertical direction Z′Z and in the horizontal plane, typically in the directions X′X and Y′Y, are preferably controlled when accelerating and decelerating such that, when the anode has lowered or raised within the scope of step ii) of the present method according to the invention, it undergoes a movement as close as possible to a pure vertical translation, with axes (x′x), (y′y) and (z′z) which keep their respective directions throughout said movement. During the measurement method, the anode is moved vertically so that its lower surface passes through a plane formed by a plurality of n sound or electromagnetic wave beams, n being at least equal to two, and preferably three. As indicated in French application 04 09508, the sound waves are typically ultrasonic waves and the electromagnetic waves are typically visible light, infrared or radio waves. In a preferred method of the invention, said beams are generated using lasers.

According to the methods of the invention, this plane is horizontal or slightly inclined in relation to the horizontal plane, typically at an angle less than a 3°. As the anode is suspended and the carbon block is the lowest part of the anode, the height of the anode is advantageously measured in a phase where it is descending vertically. However, the measurement can also be made by making the anode rise vertically, provided that the disturbances of the beams by the upper surface of the anode block can be distinguished from that by the lower surface. More generally speaking, generators are placed and oriented so that when the beams that they emit are disturbed, the cause of the disturbance can be determined without ambiguity and only the disturbance by the plane part of the lower surface of the anode block are retained.

The applicant has noted that if the lower surface of the worn anodes was generally eroded along its periphery, it nevertheless maintained a plane zone perpendicular to the stem in nearly all cases, which corresponds to the lowest part of the anode block and thus serves as a basis for estimating the distance between the anode and the cathode assembly, and for which the real orientation can be estimated by measuring the inclination of the stem in relation to the vertical axis. In the scope of the present invention, this plane zone is used either by maintaining the beam plane in a fixed direction (preferably the horizontal plane) and by considering the fact that the lowest part of the periphery of this plane zone which first disturbs said beams, or by orienting the beam plane so that it becomes parallel with said plane zone. In this case, the generators are advantageously grouped together on a platform whose orientation can be dictated in relation to the horizontal plane such that said plane beam becomes orthogonal to the direction (z′z) of the anode stem, the inclination of which was measured previously.

During the vertical displacement of the anode, for its height to be measured (step ii), the position of the point of attachment is constantly known: its vertical distance in relation to the reference level (N) is deduced from the vertical position of the particular point given by the incremental displacement sensor and its coordinates in the horizontal plane are related to those of the positioning device. When the latter is secured to a service machine for handling an anode near an electrolysis cell, these coordinates in the horizontal plane are determined by the respective positions of the carriage and the mobile gantry whose directions of movement are parallel to directions X′X and Y′Y.

The anode is subjected to a vertical translation movement, preferably downwards, so that the lower surface of the anode block passes through the plane of the beams. Each time one of the n beams is disturbed by the lower surface of the anode block, the vertical position hᵢ of said point of attachment is measured.

As indicated in French application 04 09508, the disturbance of said beams can be detected in several ways. According to a first embodiment, a sound or electromagnetic wave detector is placed opposite a sound or electromagnetic wave beam generator so that the detector can detect the beam produced by the generator, and the moment when the anode block interrupts transmission of said beam to the detector is noted. According to another embodiment, a sound or electromagnetic wave detector and a sound or electromagnetic wave beam generator are placed opposite a surface so that the detector can detect the beam produced by the generator and reflected by said surface. These elements can be placed in a triangle so as to form a plane. As in the first embodiment, the moment is recorded when the lower surface of the anode block interrupts transmission of said beam to the detector.

According to yet another embodiment, a sound or electromagnetic wave detector and a sound or electromagnetic wave beam generator are placed so that the detector can detect the beam produced by the generator and reflected by the anode block. The moment is then noted when the lower surface of the anode block passes through said beam, such that the anode block reflects (measurement while descending), or no longer reflects (measurement while rising) all or part of the said beam towards the detector. Tests have shown that the surface reflectivity of a new or worn anode was sufficient to enable satisfactory operation of this embodiment, even if the reflecting surface is not perfectly perpendicular to the beam. Furthermore, even if the receiver receives a diffracted beam and not the reflected beam, the intensity received is sufficient to characterise the presence of the surface that blocks the beam. This embodiment has the advantage of making it possible to geographically place the detector and the generator in the same place, the means used for this measurement thus becoming an easily mobile and stand-alone measuring unit.

In order to determine the actual height of the anode with sufficient accuracy, the inclination of the plane part of the lower surface of the anode block remains to be estimated by measuring the angle of inclination of the anode in relation to the vertical axis. As it is not possible to foresee which direction the anode will incline, the anode, particularly its stem, is advantageously observed along two vertical non-parallel planes, preferably orthogonal and its angle of inclination in relation to the vertical Z′Z is considered as having two components: the angles α and β made by the anode stem with these two vertical planes, respectively. Preferably, these planes pass through the anode stem point of attachment and are perpendicular to two horizontal directions V′V and W′W respectively, orthogonal between each other, referred to as the aiming direction. We will note α as the angle of inclination in relation to the vertical plane perpendicular to the first direction (V′V) and β as the angle of inclination in relation to the vertical plane perpendicular to the second direction (W′W).

A first solution for estimating the angle of inclination of the anode compared to the vertical axis is to use at least one camera placed facing each of these vertical planes, at a certain distance, typically a few meters, from the anode and directed towards the anode rod. With this camera placed and directed in this manner, it is possible to measure, either directly or using image analysis software, the angle of inclination of the stem in relation to the vertical plane passing by the aiming direction V′V (W′W respectively), i.e. perpendicular to the other direction W′W, (V′V respectively).

With this solution, all pairs of orthogonal directions (V′V; W′W) can be selected, in particular (X′X, Y′Y). Preferably, the vertical planes orthogonal to X′X and Y′Y are chosen, insofar as they allow the anode to be targeted in directions essentially orthogonal to the side faces of the stem and the anode block.

A second solution for estimating the angle of inclination of the anode in relation to the vertical axis is to use at least one means of aiming, for example a laser rangefinder, placed facing each of said vertical planes, at a certain distance, typically a few meters, from the anode and directed towards the anode stem in an aiming direction (V′V) (W′W respectively), in order to be able to measure the distance which separates the anode stem from this means of aiming along said aiming direction.

Advantageously, in order to benefit from better reception of the reflected or diffracted beams on one face of the stem, the aiming direction (V′V) (W′W respectively) is essentially parallel to the direction X′X (Y′Y respectively), i.e. that it makes an angle less than 25°, preferably 15°, and still preferably 10° with said direction X′X (Y′Y respectively).

In order to estimate the angle of inclination of the stem in relation to each of these vertical planes within the scope of this second solution, an initial method consists in placing, facing this plane, m aiming means, one after the other, at a known distance Hj (j=l, m) from the reference level (N). These means of aiming measure all the distances dj (j=l, m) which separate them from the anode stem at the same time. The inclination is then estimated by linear regression on all the points read (dj, Hj). The estimate is all the more accurate as the distance between the most distant of these means of aiming approaches the length of the anode stem.

Another way to proceed for this second solution is to place only one means of aiming facing each of said vertical planes, but to measure the distance dj which separates said means of aiming from the anode stem m times during the vertical movement of the anode and noting, during this measurement, the is position hⱼ of the point of attachment. The inclination is estimated by linear regression over all the points (dj, hj), the estimate being all the more accurate as the time interval between the first and last measurement is greater and corresponds typically to a movement of the anode stem over a distance close to the height of the latter.

Lastly, these two variants can be combined by performing a simultaneous measurement several times on several rangefinders and averaging the results. This last method may appear advantageous when an accurate estimate of the inclination of the rod is desired after relatively short anode travel, substantially lower than the length of the anode stem. This may prove advantageous, particularly if the first mode of operation, described below, is implemented, which requires that the inclination of the stem be known before the lower face of the anode block disturbs the beams.

A third solution for estimating the angle of inclination of the anode in relation to the vertical axis consists in using two groups of coplanar beams according to the general method described in French application 04 09508, the beams of each of these groups additionally being positioned in a horizontal plane and globally oriented perpendicularly to an edge of the anode block, in such a manner that they are disturbed by a single and sole edge of said block. As the edges of the lower surface of a worn anode block remain essentially parallel to directions X′X and Y′Y, the aiming directions V′V and W′W coincide with X′X and Y′Y and a group of horizontal coplanar beams, globally oriented along the direction (X′X), (Y′Y respectively), are used to estimate the inclination in relation to each of said vertical planes. Advantageously, the coplanar beams of each group are parallel amongst each other, oriented along a first horizontal direction (X′X, Y′Y respectively) and each have a known position along the perpendicular horizontal direction, referred to as the second horizontal direction (Y′Y, X′X respectively).

The measurement of anode stem inclination in relation to the vertical plane perpendicular to the first horizontal direction (X′X, Y′Y respectively) is made during the vertical movement of the anode, in the following manner:
a) while the anode is descending, each time a beam fᵢ of the group oriented along this first horizontal direction (X′X, Y′Y respectively) is disturbed by the lower surface of the anode block passing through it, the vertical position (hᵢ) of the point of attachment is measured;
b) knowing the difference in height H existing between the plane of the beams and the reference level (N), and by designating the point of attachment O as the origin of the coordinate system in plane OYZ perpendicular to X′X (OXZ perpendicular to Y′Y, respectively), it is established that the ordinate along Z′Z of the beam disturbance point is (hᵢ−H).
c) knowing the position Yᵢ (Xᵢ, respectively) along the second horizontal direction (Y′Y, X′X, respectively) of each of the beams fᵢ, the shape and average slope of the projection on OYZ (OXZ, respectively)—of the edge of the block that disturbs said beams, by performing a linear regression on all the points recorded. The angle that this edge makes with the horizontal, projected on the plane OYZ (OXZ, respectively) is considered representative of the angle that the stem makes with the vertical projected on this same plane.

For example, by proceeding in this manner with the first group of beams oriented according to X′X, n points are recorded in the coordinate system OYZ, the centre O of which is the point of attachment. These points have coordinates (Yi, Zi), Yi being given by the position of the beam fᵢ along the direction Y′Y and Zi being equal to (hᵢ−H). The edge projected on the plane OYZ bears on a line obtained by linear regression on all these points and has the equation:

$$Z = {a}_{0} + {a}_{1} * Y$$

$$with$$

$${a}_{0} = \frac{( {\sum }_{i = 1}^{n} {Y}_{i}^{2} ) ( {\sum }_{i = 1}^{n} {Z}_{i} ) - ( {\sum }_{i = 1}^{n} {Y}_{i} {Z}_{i} ) ( {\sum }_{i = 1}^{n} {Y}_{i} )}{n ( {\sum }_{i = 1}^{n} {Y}_{i}^{2} ) - {( {\sum }_{i = 1}^{n} {Y}_{i} )}^{2}}$$

$$and$$

$${a}_{1} = \frac{n ( {\sum }_{i = 1}^{n} {Y}_{i} {Z}_{i} ) - ( {\sum }_{i = 1}^{n} {Y}_{i} ) ( {\sum }_{i = 1}^{n} {Z}_{i} )}{n ( {\sum }_{i = 1}^{n} {Y}_{i}^{2} ) - {( {\sum }_{i = 1}^{n} {Y}_{i} )}^{2}}$$

The slope of this line enables the inclination β of the anode to be estimated in relation to the vertical plane OXZ, perpendicular to Y′Y:

β=Arctan(a₁).

An estimation of the distance of this line projected on OYZ at the point of attachment is also obtained, which is given by

$$d = \frac{{a}_{0}}{\sqrt{{a}_{0}^{2} + {a}_{1}^{2}}} .$$

By proceeding in this same manner with the second group of beams oriented according to Y′Y, the value of the inclination α of the stem in relation to OYZ can be obtained.

It is possible to use non-parallel coplanar beams, although still essentially oriented along a common direction parallel to X′X or Y′Y, the price of adding corrective terms accounting for the shift in orientation of each of the beams in relation to this common direction.

The two groups of coplanar beams used in the scope of this third solution form horizontal planes each placed at a given fixed distance from the reference level (N). They may form a fixed non-horizontal plane but here again, at the price of adding corrective terms. They are a priori distinct from the group of coplanar beams that is used in the scope of step ii) of the method according to the invention, although according to the mode of operation chosen, the latter can be chosen to also form one of the two groups used in the scope of this third solution.

Naturally, these three solutions can be combined: for example, the first angle α can be estimated using a series of rangefinders or a group of beams forming a fixed horizontal plane and estimate the β using a camera. In other words, the estimation of each component (α or β) of the inclination of the anode in relation to the vertical Z′Z can be made using a process step different from that used for the other component, the method step relative to each component being chosen among one of the three solutions proposed above, although limited to the estimation of this sole component (α or β).

Once the inclination of the stem in relation to the vertical Z′Z is known, we can proceed according to two different modes of operation. In the first mode of operation, during step ii) a group of beams is used that forms a variable plane that can be oriented perpendicularly to the stem, thus in a manner parallel to the residual plane surface of the lower face of the anode block: said inclination must thus be known before the lower face of the anode block disturbs said beams. In the second mode of operation, during step ii) a group of beams forming a fixed plane is used and a global estimation calculation is performed taking into account all data measured during the vertical movement of the anode.

In the first mode of operation, the n coplanar beams used in step ii) are advantageously emitted by generators grouped together on a platform that can be pivoted by independent rotations, about two axes orthogonal to one another. This thus requires a first measurement step intended to estimate the angle of inclination of the anode in relation to Z′Z, a second step during which the virtual plane formed by the beams is inclined according to the inclination of the stem, typically by rotating said platform, and a second step corresponding to step ii). The first two steps must be performed sufficiently rapidly, before the lower face of the anode block disturbs the beams.

In this manner, for example, after having characterised the inclination of the stem by angles α and β that the anode stem makes in relation to the planes perpendicular with the horizontal directions V′V and W′W, respectively, the platform, initially placed at a distance H of the reference level, is made to rotate an angle α about said first axis that was placed parallel to W′W and at a distance f, along direction V′V, from the point of attachment, then a rotation of angle β′=arctan(cos α tan β) about the second axis, resulting from the rotation of angle α of W′W. The plane of the beams is thus oriented perpendicularly to the anode stem. Then, the vertical movement of the anode exposed in step ii) is carried out. During this vertical movement of the anode, the n values hᵢ of the position of the point of attachment are recorded during the interruption of the n beams. Then, the average of the values (hᵢ) is calculated in order to deduce the characteristic position h̅ of where the plane of beams is crossed through by the plane part of the lower surface of the anode block. The length L₀ of the anode is then estimated by the following expression:

$${L}_{0} = \frac{( H - \overline{h} ) cos α - f sin α - \overline{Y} tan {β}^{′}}{cos {β}^{′} ( 1 + {tan}^{2} {β}^{′} )}$$

where Y̅ is the coordinate along W′W of the barycentre of the points where the beams are disturbed. If the beams are all parallel to V′V, Y̅ is the average of the coordinates along W′W of these beams.

In the second mode of operation, the n coplanar beams used in step ii) are advantageously emitted by generators grouped together on a fixed platform, and preferably form a horizontal virtual plane located at a distance H from the reference level (N). In this second mode of operation, it is not necessary to know the inclination of the stem before the lower face of the anode block disturbs the beams.

In this second mode of operation, the chronology of steps i), ii) and iii) are followed and the estimation is made in the following manner:
a) while the anode descends, each time a beam is disturbed as the lower surface of the anode block passes through it, the vertical position (hᵢ) of the point of attachment is measured.
b) an average h̅ of the vertical positions hᵢ is made by attributing this position to a characteristic point of the break of the plane of beams by the plane part of the lower surface of the anode block.
d) the height of the anode is thus deduced by the approximate expression below:

$${L}_{0} = \frac{( H - \overline{h} ) - F sin α}{cos α cos {β}^{′} ( 1 + {tan}^{2} {β}^{′} )} - \overline{Y} \frac{tan {β}^{′}}{cos {β}^{′}}$$

where β′=arctan(cos α tan β), Y̅ is the coordinate along W′W of the barycentre of the points where the beams are disturbed, and F is a corrective term, particularly linked to the shape effect of the periphery of the plane zone of the lower surface of the anode block. As angle α is small, corrective terms proportional to

$$\frac{1 - cos α}{cos α} ,$$

thus in the order of α² (α express in radians), were number neglected.

Preferably, the n beams are grouped and oriented so that they cut through just one single edge of the anode block. For this reason, preferably n electromagnetic or sound beam generators are used, placed so that they emit n coplanar beams inclined less then 25°, preferably less than 15°, preferably still less than 10°, in relation to a direction parallel to X′X or Y′Y.

If X′X (Y′Y, respectively) was selected as the overall direction of the beams, the corrective term F is near (b−r), where b is the half-length of the anode block along X′X (Y′Y, respectively) and r is the average radius of the edge wear radius, if it is circular or even the half-axis along X′X (Y′Y, respectively) if it is elliptical. Advantageously, this corrective term F is determined beforehand from statistical measurements and can account for other factors, such as the more or less correct linearity of the edge passing through the beams, the receiving sensitivity of the reflected or diffracted laser beam by the rounded edge, etc.

In the event the third solution described above is used to estimate the inclination of the stem, the coplanar beams used in the scope of this second mode of operations can correspond to one of the two groups used in said third solution. However, in order to obtain a correct estimate of the inclination of the anode, one must ensure that the points where the beams are disturbed correspond to the same edge.

In a preferred embodiment, the means are chosen to measure the inclination of the anode and the coplanar beams used in step ii) in such a manner that they are implemented in one single aiming direction only. One or several rangefinders can be used, for example, to measure the α component of the inclination of the stem in relation to the vertical plane perpendicular to X′X, a camera to estimate the β component in relation to the vertical plane passing through X′X and a group of coplanar beams globally oriented along X′X and forming a plane with an orientation that is variable (first mode of operation) or fixed and preferably horizontal (second mode of operation). Typically, the rangefinder(s) aim(s) at the anode stem along a direction inclined less than 25°, preferably less than 15°, and still preferably less than 10° in relation to the aiming direction. Furthermore, typically, the coplanar beams aim at the anode stem along a direction inclined less than 25°, preferably less than 15°, and still preferably less than 10° in relation to the aiming direction.

As axis X′X is associated with the axis of the movement of the anode gripping member that is perpendicular to the anode frame, this embodiment is particularly adapted to a measurement performed when the anode is moved near the electrolysis cell while being removed from or installed in the electrolysis cell. In this preferred embodiment of the invention, all the means used for on-the-fly measurement are advantageously grouped together in a stand-alone and mobile measurement unit that can be brought near the zone where the anode is to be replaced, in the alley located between two electrolysis cells. When it is installed for the measurements, the mobile unit oriented to that the direction (X′X) is essentially parallel to the direction of the small side of the electrolysis cell and that said means are oriented aiming toward the location of the anode to be replaced.

In a simplified variant of said preferred embodiment, only the angle of inclination α of the anode stem is measured in relation to the vertical plane parallel to the anode frame, i.e. perpendicular to the axis (X′X) and cameras are used to simply check that the inclination β remains limited to a value at most equal to a critical value, typically 1°.

The applicant noted that, during handling operations for anode replacement, once extracted from the cell, the worn anode has an anode block that generally has a thicker anode covering towards the outside of the cell and/or defects due to a lack of carbon in the parts located towards the interior of the cell. The anode thus tends to essentially incline in relation to the vertical plane passing through (Y′Y). The angle α, which in this case is the angle of inclination in relation to the vertical plane perpendicular to (X′X), is thus substantially greater than β, the angle of inclination in relation to the vertical plane perpendicular to (Y′Y), and its influence height estimate is amplified in relation to the “leverage” effect formed by the corresponding dimensions of the anode block.

In this variant, the unit of measure describe above is used, which groups together measurement means using a common global aiming direction essentially parallel to direction X′X. The beam generators are grouped together in this unit so that the beam plane can pivot an angle α about an axis parallel to the direction (Y′Y) (first mode of operation) or, on the contrary, be maintained fixed and horizontal, at a given distance H from the reference level (N) (second mode of operation).

In the case of the first mode of operation, the mobile unit is placed at the point of attachment so that the pivot axis of the plane of coplanar beams is parallel to (Y′Y), at a distance f from the point of attachment along direction (X′X). The angle of inclination α of the anode stem is measured first, then the plane of beams is pivoted said angle α in relation to the horizontal plane. The anode is then moved vertically until the beams are disturbed by the lower surface of the anode block. Each times a beam i is disturbed, the position hᵢ of the point of attachment is recorded and an average position h̅ of the point of attachment is deduced, corresponding to the disturbance of the plane of beams. The beams are arranged in such a manner so that the barycentre of the points that disturb the beam are vertical from the point of attachment (or near it, typically less than 10 mm), the length L₀ of the anode can be estimated by the simplified formula:

L₀=(H− h̅)cos α−f sin α

In the case of the second mode of operation, the mobile unit is placed at the point of attachment so that the aiming means used to estimate the inclination of the anode stem are at a distance f from the point of attachment along direction (X′X). The plane of beams is maintained in a fixed direction. Preferably, this plane is horizontal. The generators are grouped together so that they generate n sound or electromagnetic beams, n being at least equal to two, preferably three, coplanar and slightly inclined in relation to XX′, i.e. typically an angle less than 25°, preferably less than 15°, and still preferably less than 10° in relation to (X′X), the average inclination of the n beams being as low as possible, preferably less than 10°.

In order to use the measurements taken in the scope of this variant, the applicant noted that the plane zone of the lower surface of the anode blocks had a periphery with “edges” that essentially retain the directions (x′x) and (y′y) of the anode axes, such that coplanar beams, inclined slightly in relation to (X′X) will be disturbed by a low edge parallel to (y′y). As indicated above, the worn anode leaving a cell has this low edge toward the outside of the cell, such that said beams are not influenced by the lower surface of the anode block before being broken cleanly by the anode block as a result.

The beams are oriented so that the barycentre of the points disturbed are located nearby, typically less than 10 mm, from the vertical of the point of attachment.

At time tᵢ, when the beam is broken by the carbon block of the anode passing through it, the vertical position hᵢ of said point of attachment is measured. An average h̅ of the vertical positions hᵢ is calculated and the height of the anode is estimated using the simplified formula: L₀=(H− h̅)−Fα, where α is expressed in radians and where F is a correcting factor related to the rounded shape of the edges and determined from statistical measurements.

This second mode of operation does not require that the angle of inclination of the anode stem be known before the beams are disturbed by the lower face of the anode block.

The coplanar beams used in the scope of this second mode of operation can be parallel between themselves and to direction X′X: in this case, they can also be used to estimate the inclination β by using the third solution described above. In this case, the measurement unit can be free of cameras. However, as the inclination is estimated only by the extrapolation of data coming from disturbance points supposedly located on the same edge, the risk of error is great if one of these points is located on another edge. Such a mobile unit should thus be used with reliable means, on-board said mobile unit or otherwise, to verify that the beam disturbance points are on the same edge.

Preferably, the measuring unit used in the context of the invention includes two separate groups of means, the function of one being to estimate the angle of inclination of the anode stem, and the other designed to read the positions of the point of attachment each time the beams are broken. Another object of the invention is therefore a mobile measuring unit comprising:
n electromagnetic or sound beam generators arranged so that they emit n coplanar beams inclined less than 25°, preferably less than 15°, and still preferably less than 10°, in relation to an aiming direction, n being at least equal to two, and preferably three,
n receivers, each receiver being able to detect disturbances to the corresponding emitted beam,
and at least one rangefinder aiming in a direction inclined less than 25°, preferably less than 15°, and still preferably less than 10°, in relation to said aiming direction.

Advantageously, this mobile unit also comprises a camera pointed in a direction inclined less than 25°, preferably less than 15°, and still preferably less than 10°, in relation to said aiming direction and which enables the inclination of the stem to be measured in relation to the vertical plane passing by the aiming direction.

According to a rather frequent embodiment, at least two worn anode assemblies are replaced at a time by two new anode assemblies. In this case, at least two anode grips are used and the mobile measurement unit can be arranged so that it comprises all coplanar beam generators and all rangefinders intended to measure the inclinations of at least two stems. Steps are thus taken to place the unit in such a manner so that each rangefinder is arranged in the vertical plane passing through the point of attachment of the corresponding anode and parallel to the direction (X′X) of the large side of the new anodes and that the average direction of the coplanar beams correspond to said direction (X′X). Although this requires that the rangefinders and the groups of coplanar beam generators be separated, thereby increasing the overall dimensions of the mobile measurement unit. The rangefinders and the coplanar beam generators can thus be grouped together relative to at least two anodes. Advantageously, when the mobile unit must measure the height of two anodes, it is placed between the anodes and the average aiming directions are arranged as symmetrical as possible in relation to X′X, the mobile unit being placed in said direction X′X at a sufficient distance f so that each of the aiming angles of the beams relative to an anode do not exceed + or −20° in relation to (X′X) and that the average aiming angle of the beams and the rangefinder relative to an anode does not exceed + or −10° in relation to (X′X).

Another subject of the invention is the use of the method of measuring, on the fly, the height of an anode as described above in the scope of a method for replacing worn anodes in a cell for producing aluminium by molten salt electrolysis as that described in French application No. 04 09508. In an advantageous method, the mobile measuring unit described above is used by bringing it close to the zone where the anode is to be replaced, by taking the alley between two electrolysis cells (the measuring unit can, for example, be placed on a vehicle on the ground or suspended from a mobile gantry) and by directing said measuring unit so that direction (X′X) coincides with the direction of the small side of said electrolysis cell.

### FIGURES

FIG. 1 shows a front view of a new anode placed vertically, just before a gripping member grasps it.

FIG. 2 schematically represents the anode grasped by the gripping member, the various systems of axes (x′x, y′y, z′z), (X′X, Y′Y, Z′Z) and (V′V, W′W, Z′Z), the point of attachment, corresponding to the origin O of coordinate system OXYZ, and the means used to measure the height of the anode on the fly.

FIG. 3 illustrates a front view of a typical electrolysis hall for the production of aluminium and including a service unit shown schematically.

FIG. 4 illustrates the use of a particular embodiment of the on-the-fly anode height measurement method according to the invention, as part of the process to replace worn anodes in a cell for producing aluminium by molten salt electrolysis.

### EXAMPLE

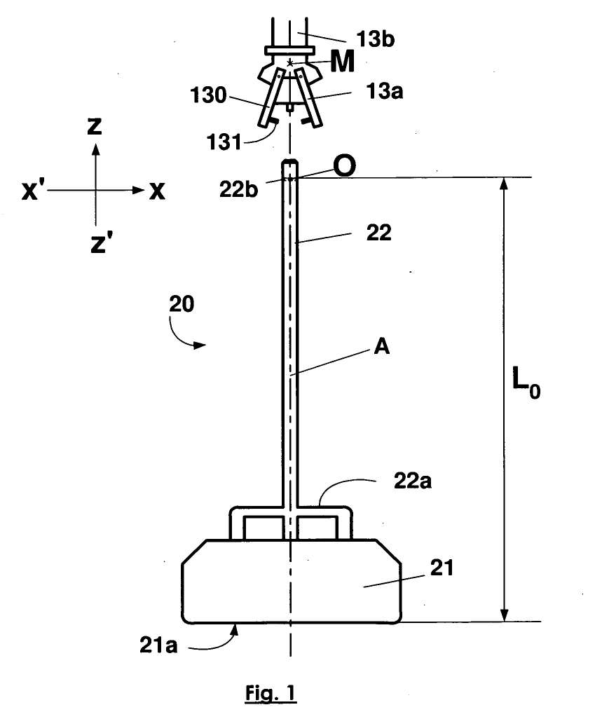

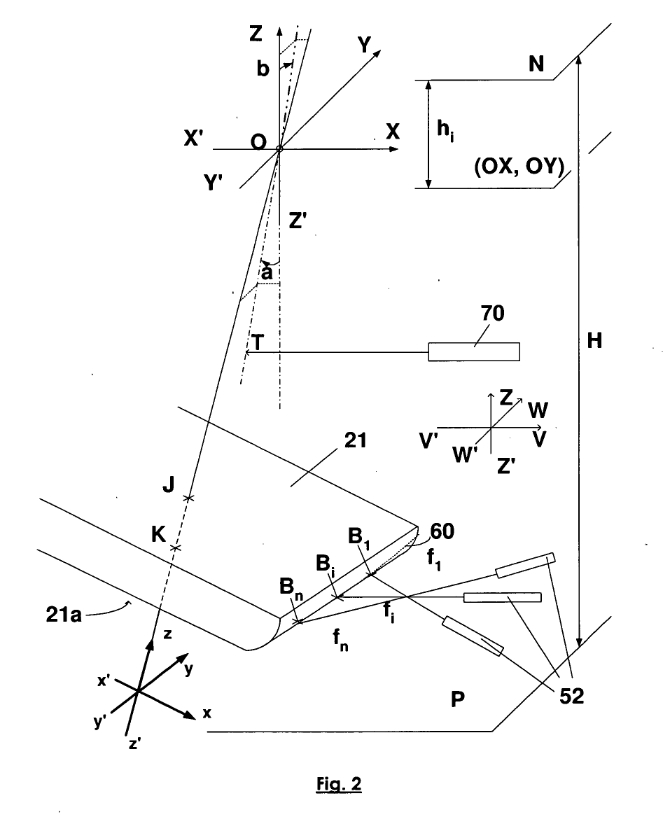

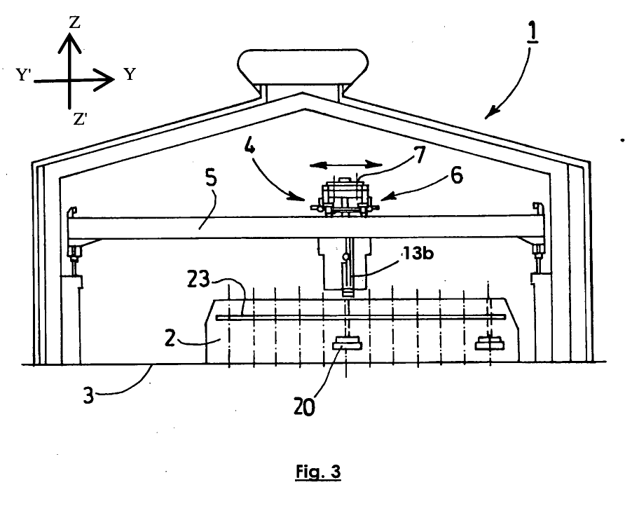

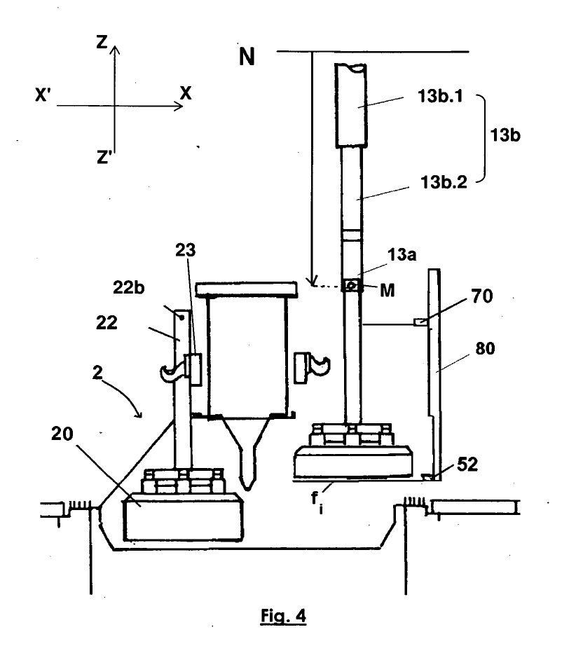

The example, illustrated in FIGS. 1 to 4, presents a particular embodiment of the measurement method according to the invention, in which a mobile measurement unit 80 is used, comprising means globally oriented along X′X.

The anode 20 comprises a stem 22 and an anode block 21. When the anode is new, it is perfectly balanced such that the directions x′x, y′y, z′z correspond to those of its axes of symmetry. The gripping member 13a is arranged such that, when the new anode is suspended, the directions x′x and y′y remain parallel to the directions X′X and Y′Y which are parallel to the small and the large side of the electrolysis cell respectively, the direction of the large side coinciding with that of the anode frame 23 to which the anode is connected. When it is suspended, the worn anode no longer has its initial balance so that its axes x′x, y′y, z′z are no longer parallel to the axes X′X, Y′Y and Z′Z. The problem is to obtain an estimate that is as accurate as possible of the distance L₀ between the lower surface 21a of the anode block 21 and the point of attachment O, without immobilizing the anode, and no matter how worn it is.

The gripping member 13a moves vertically and grasps the anode so that the stem does not turn about its axis z′z. This gripping member, used to change anodes 20 in an electrolysis cell 2, is secured to a positioning device 13b attached to the carriage 7 of a service machine 6 that rolls on a mobile gantry 5 able to be translated in the electrolysis workshop 1, above and along series of electrolysis cells. Said positioning device 13b is typically a telescopic arm arranged vertically, comprised of at least two masts 13b.1 and 13b.2 sliding one inside the other, mast 13b.2 being moved by an actuator and being guided by the other mast 13b.1 which is attached to the service machine 6. The gripping member 13a is an anode grip which, fixed at the end of the mast 13b.2, moves vertically, without undergoing rotation about axis z′z or significant horizontal transverse movement.

The grip comprises articulated branches 130 that pivot about a horizontal axis that remains parallel to Y′Y. Each articulated branch of the grip comprises a pawl 131, which is inserted with some play inside a bores 22b of the anode stem. Blanks (not shown) frame the other faces of the stem, such that, when the grip is closed, the end of the stem cannot undergo any relative movement, axial or transversal, in relation to the positioning device.

Said gripping member 13a is provided with a displacement sensor (not shown) which makes it possible to measure the vertical position of a particular point M of the gripping member in relation to a horizontal reference level (N). The sensor is placed so that one of its ends is fixed at the base of the mobile mast, the altitude of which serves as the horizontal reference level (N). Its other end is fixed on the particular point of the gripping member.

During the measurement method, the anode 20 is moved vertically so that its lower surface 21a crosses a horizontal plane P formed by n (n typically between 3 and 5) electromagnetic wave beams (f₁, . . . , fᵢ, . . . , fₙ) generated using laser generators 52. Plane P is located a known distance H from the reference level N.

The beams are oriented so that the barycentre of the disturbed points (B₁, . . . , Bᵢ, . . . , Bₙ) are located near the vertical of the point of attachment O, typically less than 10 mm from the latter. Direction XX′ itself corresponds to the direction of the large side of the anode and the small side of the electrolysis cell.

During the vertical movement of the anode, in order for its height to be measured (step ii), the position of the point of attachment O is constantly known: its vertical distance in relation to the reference level N is deduced from the vertical position of the particular point M given by the incremental displacement sensor and its coordinates in the horizontal plane are determined by the respective positions of the mobile gantry and the carriage carrying the service machine to which the positioning device is fixed and whose directions of movement are parallel to directions X′X and Y′Y.

The anode is subjected to a vertical translation movement, preferably downwards, so that the lower surface 21a of the anode block 21 crosses the horizontal plane P of the beams. As the worn anode is unbalanced, the lower surface 21a of the anode block is not parallel to plane P, such that said plane P cuts the anode block along a curve 60 which is not parallel to the edge of the block and such that the beams are not disturbed simultaneously.

Each time one of the n beam is disturbed by the lower surface 21a of the anode block passing through it, the vertical position hᵢ of said particular point of the gripping member is measured.

The detectors (not shown) and laser beam generators 52 are arranged so that each detector can detect the beam produced by the relevant generator and reflected by the anode block. The moment is recorded when the lower surface of the anode block crosses said beam, when the anode block reflects all or part of said beam towards the detector. This embodiment has the advantage of making it possible to geographically group together the detector and the generator in the same location.

In the case of this example, the coplanar beams (f₁, . . . , fᵢ, . . . , fₙ) cross. n parallel beams could have also been used, preferably an odd number of equidistant beams, while taking steps to ensure that the middle beam arrives vertical to the point of attachment.

To estimate the angle of inclination α, in this example, a laser rangefinder 70 is used, which aims at stem 22 along X′X. Inclination α is determined by measuring the horizontal distance between the laser rangefinder 70 and a point T of the stem 22 at several different times.

The distance dj to the anode stem is therefore measured m times during the vertical movement of the anode and, during this measurement, the position hᵢ of the point of attachment O is recorded. The inclination is estimated by linear regression on all the points (dj, hj). The time interval between the first and last measurement is selected to correspond to a movement of the anode stem of about 1 meter. The thickness of the stem (typically 50 mm or more) is such that a reflection or a diffraction of the laser beam on the face of the stem can always be obtained, in spite of the inclination of the latter (typically less than 3°).

The laser beam generators 52, the detectors and the laser rangefinder 70 are grouped together on the same mobile measuring unit 80, assembled on a motor vehicle able to circulate in the alley located between two electrolysis cells, perpendicular to the lane 3, and which is used to bring said measuring unit near to the zone where the anode is to be replaced.

The measurement is performed after the anode is disconnected from the anode frame 23 and a sufficient distance from the cell 2 so that it can rise vertically. Preferably, the anode grip is raised until point M of the anode grip reaches a given vertical position h₀, then the anode is lowered until the anode block disturbs all the parallel n beams. Preferably, the starting altitude is sufficiently high so that the estimation of the slope a takes place with a height difference of around 1 meter.

1. A method for on-the-fly measurement of the length along direction (z′z) of a anode for producing aluminium by molten salt electrolysis, said anode comprising a stem which extends substantially along an axis (A), in direction (z′z), and whose orthogonal section is a rectangle whose sides follow directions (x′x) and (y′y), as well as an anode block of right-angled parallelepipedic overall shape, the height of which extends along direction (z′z) and the orthogonal section of which has sides substantially parallel with those of the section of said stem;
the method in which:
i) said anode is suspended from a gripping member which grasps, at the level of the point of attachment (O), the anode stem so that it cannot turn about its axis (A);
said gripping member is guided such that it moves along the vertical axis Z′Z and such that, when it grasps a new anode, directions (x′x) and (y′y) remain essentially parallel to two given horizontal directions (X′X) and (Y′Y), orthogonal between each other;
said gripping member being fitted with a displacement sensor capable of measuring the vertical position of the point of attachment (O);
ii) said gripping member is moved vertically so that the lower surface of the anode block passes through at least a plane (P) formed by a plurality of n sound or electromagnetic wave beams (f₁, . . . , fᵢ, . . . , fₙ), and said displacement sensor is used to record the vertical position hᵢ (i=1 to n) of said point of attachment each time one of said beams is disturbed by the lower surface of the anode passing through it;
said method being characterised in that the angle of inclination of the axis (z′z) of the anode stem is also measured in relation to the vertical Z′Z in order to describe this angle of inclination and the values measured hᵢ (i=1 to n), the distance between the point of attachment (O) and the lower surface of the anode block.

2. The on-the-fly measurement method according to claim 1, in which said gripping member is fitted on a positioning device which is attached to the carriage of a service machine, said carriage moving on a mobile gantry ready to be translated above and along the series of electrolysis cells.

3. The on-the-fly measurement method according to claim 2, in which said displacement sensor is rigidly fixed to the part of the positioning device that is attached to the service machine.

4. The on-the-fly measurement method according to claim 1, in which the measurement is made while the anode is descending.

5. The on-the-fly measurement method according to claim 1, in which said n coplanar beams (f₁, . . . , fᵢ, . . . , fₙ) are in a fixed plane, typically horizontal and located a given distance H from the reference level (N).

6. The on-the-fly measurement method according to claim 1, in which said n coplanar beams (f₁, . . . , fᵢ, . . . , fₙ) are in a plane of variable orientation, the generators being grouped together on a platform whose orientation can be dictated in relation to the horizontal plane such that said plane beam becomes orthogonal to the direction (z′z) of the anode stem.

7. The on-the-fly measurement method according to claim 1, in which the inclination of the stem is estimated by measuring two angles a and b made by the anode stem with to non-parallel vertical planes respectively, preferably passing through said point of attachment (O) and perpendicular to two horizontal directions (V′V) and (W′W) orthogonal between each other, referred to as aiming directions.

8. The on-the-fly measurement method according to claim 7, in which, for each of said vertical planes, at least one camera is placed opposite said vertical plane, at a certain distance, typically a few meters, from the anode and orienting it toward the anode stem so that it is possible to measure, directly or using image analysis software, the angle of inclination of the stem in relation to the vertical plane passing by the aiming direction (V′V or W′W).

9. The on-the-fly measurement method according to claim 7, in which, for each of said vertical planes, at least one aiming means is used, such as a laser rangefinder for example, by placing the face of said vertical plane at a certain distance, typically a few meters, from the anode and oriented toward the anode stem in the aiming direction (V′V) (W′W respectively), in order to be able to measure the distance separating the anode stem from this aiming means along said aiming direction.

10. The on-the-fly measurement method according to claim 9, in which said direction (V′V) (W′W respectively) is essentially parallel to the direction X′X (Y′Y respectively), i.e. making an angle less than 25°, preferably 15°, and still preferably 10° with said direction X′X (Y′Y respectively).

11. The on-the-fly measurement method according to claim 9, in which the inclination is determined by m aiming means placed one above the other at a known distance Hj (j=1 m) from the reference level (N), and which simultaneously measures all distances dj (j=1 m) which separate them from the anode stem.

12. The on-the-fly measurement method according to claim 9, in which the measurement of the inclination is made using a single rangefinder and where the measurement of the distance dj separating said means from the anode stem is performed m times during the vertical movement of the anode, by recording the position hⱼ of the point of attachment during this position measurement.

13. The on-the-fly measurement method according to claim 7, in which the directions V′V and W′W coincide with X′X and Y′Y and in which, for each of said vertical planes, a group of horizontal coplanar beams is used that are globally oriented along the direction (X′X), (Y′Y respectively), said beams preferably being parallel to one another, oriented along a first horizontal direction (X′X, Y′Y respectively) and each having a known position along the perpendicular direction, said second horizontal direction (Y′Y, X′X respectively).

14. The on-the-fly measurement method according to claim 7, in which the means used to measure the inclination of the stem and the coplanar beams used in step ii) are implemented in one single aiming direction only.

15. The on-the-fly measurement method according to claim 14, in which said means used to measure the inclination of the stem and the coplanar beams used in step ii) are grouped together in a mobile and stand-alone measurement unit that can be brought near the zone of the electrolysis cell where the anode must be replaced and is implemented along direction X′X, perpendicular to the anode frame.

16. The on-the-fly measurement method according to claim 15, in which the inclination of the stem is evaluated by measuring only the a component of the angle of inclination of the anode stem in relation to the vertical plane perpendicular to (X′X), the b component of the angle of inclination simply being controlled as remaining below a given value, typically 1°.

17. The on-the-fly measurement process according to claim 16, in which said generators of n beams are grouped together on a platform able to pivot about an axis and in which:
a) the mobile unit is placed at the point of attachment so that the pivot axis of the platform of the coplanar beam generators is parallel to (Y′Y), at a distance f from the point of attachment (O) along direction (X′X), the beams being arranged so that the barycentre of the points where the beams are broken are located at the vertical from the point of attachment, or near it, typically less than 10 mm; and
b) the inclination a of the anode stem is measured first, then the plane of beams is pivoted said angle a in relation to the horizontal plane;

18. The on-the-fly measurement method according to claim 16 in which the mobile unit is placed at the point of attachment (O) so that the aiming means used to estimate the inclination of the anode are at a distance f from the point of attachment along direction (X′X), in which the plane of the beams is horizontal and in which the generators are grouped together so that they generate n sound or electromagnetic beams, n being at least equal to two, preferably three, coplanar and slightly inclined in relation to (X′X), in which the coplanar beams are oriented so that the barycentre of the disturbed points are located near the vertical of the point of attachment and in which:
a) the vertical position hᵢ of said point of attachment is measured each time a beam i is disturbed by the lower surface of the anode crossing through it,
b) an average h̅ of the vertical positions hᵢ is calculated by attributing this position to the barycentre of the disturbance points taken on the edges of the plane zone of the lower surface of the anode block.
c) the height of the anode is estimated using the simplified expression:
L₀=(H− h̅)−Fα
where α is expressed in radians and where F is a term determined from statistical measurements.

19. A measurement unit grouping together at least:
n sound or electromagnetic beams arranged so that they emit n coplanar beams inclined less than 25°, preferably less than 15°, and preferably still less than 10°, in relation to an aiming direction, n being at least equal to two, preferably three,
n receivers, each receiver being able to detect disturbances to the corresponding emitted beam,
at least one rangefinder aiming in a direction inclined less than 25°, preferably less than 15°, and still preferably less than 10°, in relation to said aiming direction
and a camera pointing in a direction inclined less than 25°, preferably less than 15°, and still preferably less than 10°, in relation to said aiming direction to enable the inclination of the stem to be measured in relation to the vertical plane passing by the aiming direction.

20. (canceled)

21. In a method for replacement of a worn anode in a cell for producing aluminum by molten salt electrolysis, the improvement comprising measuring the length of an anode by the on-the-fly method according to claim 1.
